(19) United States
(12) Patent Application Publication
(10) Pub. No.: US 2026/0244205 A1
(43) Pub. Date: Aug. 20, 2026

(54) DATA PROCESSING METHOD AND RELATED APPARATUS

(71) Applicant: Tencent Technology (Shenzhen) Company Limited, Shenzhen (CN)

(72) Inventor: Yong YANG, Shenzhen (CN)

(73) Assignee: Tencent Technology (Shenzhen) Company Limited, Shenzhen (CN)

(21) Appl. No.: 19/643,287

(22) Filed: Apr. 9, 2026

Related U.S. Application Data
(63) Continuation of application No. PCT/CN2024/115344, filed on Aug. 29, 2024.

(30) Foreign Application Priority Data
Nov. 7, 2023 (CN) 202311478788.2

(51) Int. Cl. G05D 1/226; G05D 1/648; H04L 43/106; H04L 49/55; G05D 107/70; G05D 109/10; G05D 111/30

(52) U.S. Cl. CPC G05D 1/226; G05D 1/648; H04L 43/106; H04L 49/555; G05D 2107/70; G05D 2109/10; G05D 2111/32

(57) ABSTRACT

This application discloses a data processing method and related apparatus. The method includes: obtaining a control instruction packet comprising a to-be-processed control instruction and a time stamp at which the server transmits the to-be-processed control instruction; determining whether the to-be-processed control instruction is time sensitive; in response to the to-be-processed control instruction being time sensitive, reading the time stamp from the control instruction packet, and obtaining the to-be-processed control instruction, the time sensitive control instruction being used for cooperatively controlling, with another control instruction, a terminal to complete a common task, and the terminal responds to the time sensitive control instruction and the another control instruction based on a preset sequence; determining a transmitting order of the to-be-processed control instruction based on the time stamp; and transmitting the to-be-processed control instruction to the terminal based on the transmitting order.

### RELATED APPLICATION

This application is a continuation application of PCT Patent Application No. PCT/CN2024/115344, filed on August 29, 2024, which claims priority to Chinese Patent Application No. 202311478788.2, filed with the China National Intellectual Property Administration on November 7, 2023 and entitled "DATA PROCESSING METHOD AND RELATED APPARATUS", each of which is incorporated herein by reference in its entirety.

### FIELD OF THE TECHNOLOGY

This application relates to the field of communication technologies, and in particular, to a remote control technology.

### BACKGROUND OF THE DISCLOSURE

With the rapid development of network communication technologies, the network communication technologies are very widely applied to industrial Internet scenarios nowadays, and especially, to the field of industrial intelligent manufacturing, for example, a remote control system for an industrial robot based on a network communication technology, or remote medical treatment based on a network communication technology. Application of the network communication technologies makes industrial control more automatic and intelligent.

In these scenarios, a cloud server usually continuously delivers control instructions to a remote terminal through networks. Although currently used networks, especially a 5th generation mobile communication technology (5G) network, have high real-time performance, many uncontrollable factors exist in a network data transmission process. As a result, once a time sequence of the control instructions delivered by the server is disordered, the terminal certainly cannot work correctly.

### SUMMARY

To resolve the foregoing technical problems, this application provides a data processing method and related apparatus, to ensure that control instructions are transmitted to a terminal strictly based on the correct transmitting sequence, and ensure that the terminal can work correctly.

Embodiments of this disclosure disclose the following technical solutions.

According to an aspect, an embodiment of this disclosure provides a data processing method, performed by a computer device, and the method includes:

obtaining a control instruction packet transmitted by a server, the control instruction packet including a to-be-processed control instruction and a time stamp at which the server transmits the to-be-processed control instruction;

if it is determined that the to-be-processed control instruction in the control instruction packet is a time sensitive control instruction, reading the time stamp from the control instruction packet, and reading the to-be-processed control instruction from the control instruction packet, the time sensitive control instruction being configured for cooperatively controlling, with another control instruction, a terminal to complete the same task, and the terminal needing to respond to the time sensitive control instruction and the another control instruction based on a preset sequence when executing the task;

determining a transmitting order of the to-be-processed control instruction based on the time stamp; and

transmitting the to-be-processed control instruction to the terminal based on the transmitting order, the terminal being configured to perform a corresponding operation in the task in response to the to-be-processed control instruction.

According to an aspect, an embodiment of this disclosure provides a data processing apparatus, including an obtaining unit, a reading unit, a determining unit, and a transmitting unit;

the obtaining unit being configured to obtain a control instruction packet transmitted by a server, the control instruction packet including a to-be-processed control instruction and a time stamp at which the server transmits the to-be-processed control instruction;

the reading unit being configured to: if it is determined that the to-be-processed control instruction in the control instruction packet is a time sensitive control instruction, read the time stamp from the control instruction packet, and read the to-be-processed control instruction from the control instruction packet, the time sensitive control instruction being configured for cooperatively controlling, with another control instruction, a terminal to complete the same task, and the terminal needing to respond to the time sensitive control instruction and the another control instruction based on a preset sequence when executing the task;

the determining unit being configured to determine a transmitting order of the to-be-processed control instruction based on the time stamp; and

the transmitting unit being configured to transmit the to-be-processed control instruction to the terminal based on the transmitting order, the terminal being configured to perform a corresponding operation in the task in response to the to-be-processed control instruction.

According to an aspect, an embodiment of this disclosure provides a computer device, the computer device including a processor and a memory;

the memory being configured to store a computer program and transmit the computer program to the processor; and

the processor being configured to perform, based on instructions in the computer program, the method according to any one of the foregoing aspects.

According to an aspect, an embodiment of this disclosure provides a non-transitory computer-readable storage medium, the non-transitory computer-readable storage medium being configured to store a computer program, and the computer program, when executed by a processor, causing the processor to perform the method according to any one of the foregoing aspects.

According to an aspect, an embodiment of this disclosure provides a computer program product, including a computer program, the computer program, when executed by a processor, implementing the method according to any one of the foregoing aspects.

It can be seen from the foregoing technical solutions that, in a process in which the server transmits the control instruction to the terminal through a network, a user plane function device in the network may obtain the control instruction packet transmitted by the server, the control instruction packet including the to-be-processed control instruction and the time stamp at which the server transmits the to-be-processed control instruction. If it is determined that the to-be-processed control instruction in the control instruction packet is the time sensitive control instruction, it indicates that the to-be-processed control instruction needs to be transmitted based on a specific transmitting order, to ensure that the terminal is controlled, through the to-be-processed control instruction, to complete the task correctly. The time stamp can represent transmitting time at which the server transmits the to-be-processed control instruction. Therefore, in a process in which the to-be-processed control instruction is transmitted to the terminal through the network, to avoid a disordered time sequence of the to-be-processed control instruction caused by uncontrollable factors in the transmission process, the time stamp and the to-be-processed control instruction may be read from the control instruction packet, to accurately determine the transmitting order of the to-be-processed control instruction based on the time stamp. Then, the to-be-processed control instruction may be transmitted to the terminal based on the transmitting order, the terminal being configured to perform a corresponding operation in the task in response to the to-be-processed control instruction. For each time sensitive control instruction, an accurate transmitting order of the time sensitive control instruction is determined before the time sensitive control instruction is transmitted to the terminal, and the time sensitive control instruction is transmitted based on the transmitting order. Therefore, for a plurality of control instructions, a transmitting sequence of the plurality of control instructions is also consistent with a preset sequence configured to ensure successful task completion, that is, the transmitting sequence is correct. In this way, even if a time sequence is disordered in the transmission process, the user plane function device can still determine a correct transmitting order, to ensure that the plurality of control instructions, based on which the terminal is controlled to execute the task, can be transmitted to the terminal strictly based on the correct transmitting sequence, thereby ensuring that the terminal can work correctly.

### BRIEF DESCRIPTION OF THE DRAWINGS

To describe the technical solutions of the embodiments of this application or the related art more clearly, the following briefly introduces the accompanying drawings required for describing the embodiments or the related art. Apparently, the accompanying drawings in the following description show only some embodiments of this application, and a person of ordinary skill in the art may still derive other drawings from these accompanying drawings without creative efforts.

FIG. 1 is an architectural diagram of an application scenario of a data processing method according to an embodiment of this disclosure.

FIG. 2 is a flowchart of a data processing method according to an embodiment of this disclosure.

FIG. 3 is an example structural diagram of a control instruction packet according to an embodiment of this disclosure.

FIG. 4 is an architectural diagram of a software system of a data processing method according to an embodiment of this disclosure.

FIG. 5 is an example diagram of implementing clock synchronization based on a clock synchronization device according to an embodiment of this disclosure.

FIG. 6 is an exemplary diagram of a system architecture of a data processing method according to a related technology.

FIG. 7 is an example diagram of an entire system architecture of a data processing method according to an embodiment of this disclosure.

FIG. 8 is a structural diagram of a data processing apparatus according to an embodiment of this disclosure.

FIG. 9 is a structural diagram of a terminal according to an embodiment of this disclosure.

FIG. 10 is a structural diagram of a server according to an embodiment of this disclosure.

### DESCRIPTION OF EMBODIMENTS

The following describes embodiments of this application with reference to the accompanying drawings.

In a scenario in which a terminal is controlled to work based on network communication technologies, for example, the terminal is an industrial robot, a remote control system needs to remotely control the industrial robot based on the network communication technologies. In this case, a cloud server usually continuously delivers control instructions to a remote industrial terminal through networks. Although currently used networks, especially a 5G network, have high real-time performance, many uncontrollable factors exist in a network data transmission process. Once a time sequence of the control instructions delivered by the server is disordered, the terminal certainly cannot work correctly.

Such a control instruction that has a high requirement on the time sequence and enables that the terminal cannot work correctly once the time sequence is disordered may be referred to as a time sensitive control instruction. Correspondingly, the server installs a control application on the server to control the terminal. A control instruction delivered by the server may be specifically a control instruction delivered by the control application, and a control application delivering the time sensitive control instruction may be referred to as a time sensitive application.

An example in which the terminal is the industrial robot is used, and it is assumed that the industrial robot needs to perform the following operations to complete a task: operation (1): walk to a specified position to open a valve; operation (2): take away an object conveyed on a conveying belt; and operation (3): deliver the object to a specific position for storage. Operation (1) is performed through control by using a control instruction 1, operation (2) is performed through control by using a control instruction 2, and operation (3) is performed through control by using a control instruction 3. To implement the foregoing target task, the server needs to sequentially transmit the control instruction 1, the control instruction 2, and the control instruction 3 to the terminal. However, many uncontrollable factors may exist in a process of transmitting the control instruction through the network, for example, network congestion. Consequently, the terminal first receives the control instruction 3, then receives the control instruction 1, and finally receives the control instruction 2, and sequentially executes the received control instructions based on a receiving sequence of the control instructions. Because a time sequence of the control instructions is disordered, the industrial robot cannot correctly execute the task.

To resolve the foregoing technical problems, an embodiment of this disclosure provides a data processing method. For each to-be-processed control instruction, a correct transmitting order of the to-be-processed control instruction is determined before the to-be-processed control instruction is transmitted to the terminal, and the to-be-processed control instruction is transmitted based on the transmitting order. Therefore, for a plurality of control instructions, a transmitting sequence (or transmitting order) of the plurality of control instructions is also consistent with a preset sequence, that is, the transmitting sequence is correct. In this way, even if a time sequence is disordered in the transmission process, the user plane function device can still determine a correct transmitting order, to ensure that the plurality of control instructions that control the terminal to execute the target task are transmitted to the terminal strictly based on the correct transmitting sequence, thereby ensuring that the terminal can work correctly.

The data processing method provided in the embodiments of this application may be applied to an industrial Internet scenario based on the network communication technologies, and in particular, an industrial Internet scenario in which the time sensitive control instruction is delivered through a time sensitive application, for example, remote control of the industrial robot based on the network communication technologies, or remote medical treatment based on the network communication technologies. An application scenario of the data processing method is not limited in the embodiments of this application.

A data processing method provided in the embodiments of this application may be performed by a computer device. The computer device may be used as a user plane function (UPF) device. The UPF device is an important component in a network used when a server transmits a control instruction to a terminal. The server may be an independent physical server, a server cluster or a distributed system including a plurality of physical servers, or a cloud server providing a cloud computing service. The terminal may be used as a user equipment (UE). The terminal includes, but is not limited to, a terminal supporting a network, such as a smartphone, a computer, an intelligent voice interaction device, an intelligent appliance, an in-vehicle terminal, an aircraft, a robot, a medical terminal, a police terminal, a game terminal, an augmented reality (AR) device, a virtual reality (VR) device, a mobile Internet device, a terminal device in industrial control, a wireless device in unmanned driving, a mobile medical device in remote operation, or a smart household device. When the data processing method in the embodiments of this application is applied to an industrial Internet scenario, the terminal may be an industrial terminal.

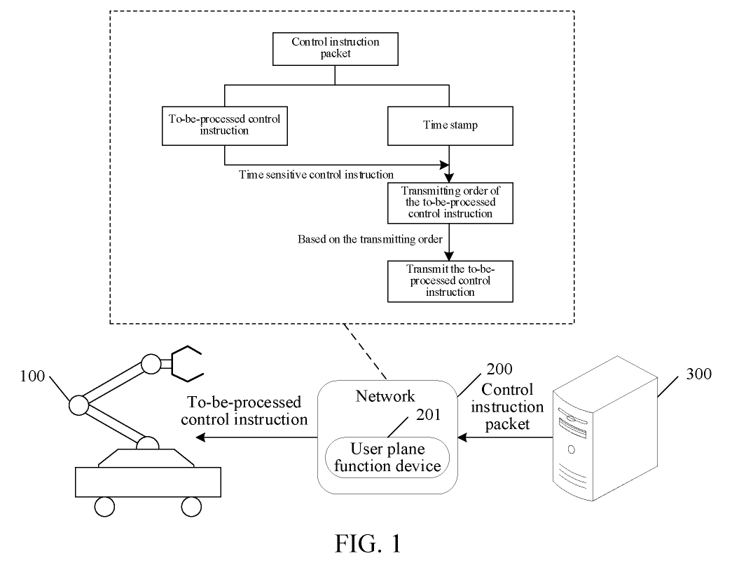

As shown in FIG. 1, FIG. 1 is an architectural diagram of an application scenario of a data processing method, and the application scenario may include a terminal 100, a network 200, and a server 300. The server 300 may transmit a control instruction to the terminal 100 through the network 200, to control the terminal to complete a target task. In FIG. 1, descriptions are provided by using an example in which the terminal 100 is an industrial robot.

In this embodiment of this disclosure, the terminal 100 may include one or more terminals, and is configured to complete a corresponding task based on control instructions transmitted in a plurality of sequences, or cooperate with other terminals to complete the same task. For example, a plurality of terminals include a terminal 1, a terminal 2, and a terminal 3, a control instruction 1 is configured for controlling the terminal 1 to complete the foregoing operation (1), a control instruction 2 is configured for controlling the terminal 2 to complete operation (2), the control instruction 3 is configured for controlling the terminal 3 to complete operation (3), and the plurality of terminals work correctly in cooperation with each other to complete the task.

The network 200 may include a user plane function device 201. The user plane function device 201 mainly supports routing and forwarding of UE service data, data and service identification, action and policy execution, and the like. In this embodiment of this disclosure, the user plane function device 201 is mainly configured to perform the data processing method provided in this embodiment of this disclosure, to transmit, strictly based on the correct transmitting sequence, a plurality of control instructions that control the terminal to execute the task, thereby ensuring that the terminal can work correctly.

A type of the network is not limited in this embodiment of this disclosure, and may be, for example, a 5G network, a 4th generation mobile communication technology (4G) network, or a 3th generation mobile communication technology (3G) network, or any types of future generation communication technologies. An example in which the network is the 5G network is mainly used in this embodiment of this disclosure for description.

With the promotion and application of the 5G technology, the 5G network is gradually applied to particular industries and enterprises. For ease of distinguishing, a 5G network that serves a mobile phone, a computer, and the like of the public and that is provided by an operator is referred to as a 5G public network, and a 5G network that provides a network communication service for a professional user (for example, a user in an industry or a user of a company) is referred to as a 5G non-public network (5G NPN). The 5G non-public network refers to a 5G professional network that implements network signal coverage in a specific area and provides a communication service for a specific user in processes such as organization, command, management, production, and scheduling. Because the 5G non-public network communication has a strong industry application feature, the 5G non-public network communication is continuously widely applied to fields such as politics, railways, transportation, electricity, emergency, esports, mining, cloud games, mobile medical, unmanned driving, smart household, and industrial automation.

The server 300 is located in a cloud, and may also be referred to as a cloud server. To control the terminal 100, a control application may be installed on the server 300. A control instruction delivered by the server 300 may be specifically a control instruction delivered through the control application, and a control application delivering a time sensitive control instruction may be referred to as a time sensitive application.

In a process in which the server 300 transmits the control instruction to the terminal 100 through the network 200, the user plane function device 201 in the network 200 may obtain a control instruction packet transmitted by the server 300. The control instruction packet is a data unit for exchanging and transmitting the control instruction in the network. A structure of the control instruction packet may be defined by a communication protocol. In a possible implementation, the control instruction packet may include a to-be-processed control instruction and a time stamp at which the server 300 transmits the to-be-processed control instruction. The to-be-processed control instruction is a control instruction that needs to be transmitted to the terminal 100, and is configured for controlling the terminal 100 to perform a corresponding action. The action herein may be, for example, moving forward, moving backward, or stopping immediately. The time stamp indicates precise time at which the to-be-processed control instruction is transmitted. A unit of the time stamp is not limited in this embodiment of this disclosure, and may be, for example, second, millisecond, or microsecond. In this embodiment of this disclosure, the unit of the time stamp may be 100 microseconds.

If the user plane function device 201 determines that the to-be-processed control instruction in the control instruction packet is the time sensitive control instruction, it indicates that the to-be-processed control instruction needs to be transmitted based on a specific transmitting order, to ensure that the terminal can be controlled to correctly complete the corresponding task through the to-be-processed control instruction.

The time stamp can represent time at which the server 300 transmits the to-be-processed control instruction. Therefore, in a process in which the to-be-processed control instruction is transmitted to the terminal 100 through the network 200, to avoid a disordered time sequence of the to-be-processed control instruction caused by uncontrollable factors in the transmission process, the user plane function device 201 may read the time stamp and the to-be-processed control instruction from the control instruction packet, to accurately determine the transmitting order of the to-be-processed control instruction based on the time stamp. Then, the user plane function device 201 may transmit the to-be-processed control instruction to the terminal 100 based on the transmitting order, and the terminal 100 is configured to complete the corresponding task in response to the to-be-processed control instruction.

For each to-be-processed control instruction, an accurate transmitting order of the to-be-processed control instruction is determined before the to-be-processed control instruction is transmitted to the terminal, and the to-be-processed control instruction is transmitted based on the transmitting order. In this case, a transmitting sequence of a plurality of control instructions is also consistent with a preset sequence, that is, the transmitting sequence is correct. In this way, even if a time sequence is disordered in the transmission process, the user plane function device may also determine a correct transmitting order, to ensure that the plurality of control instructions that controls the terminal to execute the task can be transmitted to the terminal strictly based on the correct transmitting sequence, thereby ensuring that the terminal can work correctly.

The data processing method provided in this embodiment of this disclosure may relate to the field of artificial intelligence technologies. This embodiment of this disclosure mainly automatically performs the data processing method based on the artificial intelligence technologies. In the specific embodiments of this application, when the embodiments of this application are applied to a specific product or technology, separate user permission or consent need to be obtained for data related to user information involved in an entire process, such as collection, use, and processing of the related data need to comply with the laws, regulations, and standards of related countries and regions.

Next, a data processing method provided in the embodiments of this application is described with reference to the accompanying drawings. Referring to FIG. 2, FIG. 2 is a flowchart of a data processing method. The method includes the following operations.

S201: Obtain a control instruction packet transmitted by a server.

In a scenario in which a terminal is controlled to work based on network communication technologies, the server may transmit a control instruction to the terminal through a network, to control the terminal to work. In this embodiment of this disclosure, the control instruction that currently needs to be transmitted may be referred to as a to-be-processed control instruction. The to-be-processed control instruction may be transmitted in a form of a packet, that is, the to-be-processed control instruction is carried by the packet, and the packet carrying the to-be-processed control instruction may be referred to as the control instruction packet.

Based on this, the control instruction packet may include the to-be-processed control instruction. Certainly, to facilitate accurate determining of a transmitting order of the to-be-processed control instruction subsequently, the control instruction packet may further include a time stamp at which the server transmits the to-be-processed control instruction.

Generated packets are slightly different according to different transmission protocols between the server and the terminal. The transmission protocol may be the transmission control protocol (TCP), the user datagram protocol (UDP), or the like. If the transmission protocol is the TCP, the control instruction packet may be a TCP packet. If the transmission protocol is the UDP, the control instruction packet may be a UDP packet.

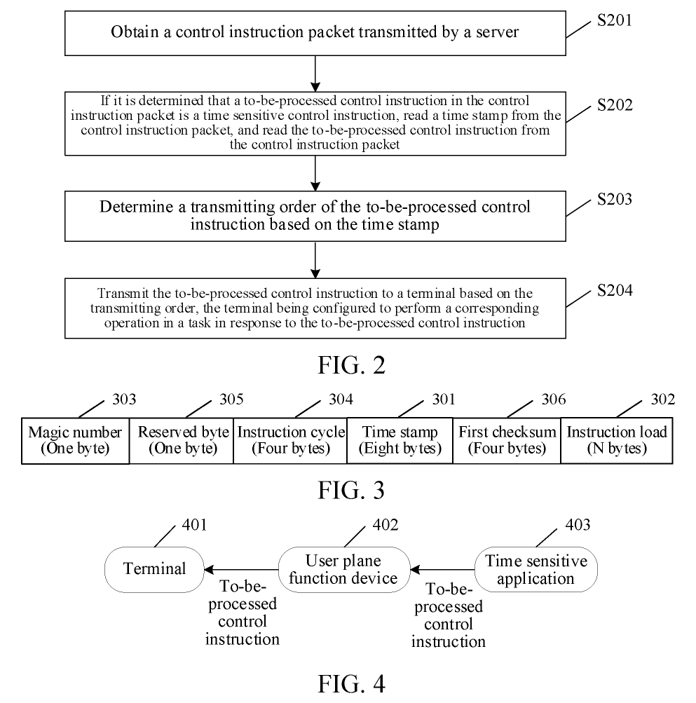

In a possible implementation, a structure of the control instruction packet may be defined through the transmission protocol, so that a user plane function device can strictly control transmitting sequences of different control instructions based on the transmission protocol. Usually, the control instruction packet may include a packet header and a packet body. The packet header includes some necessary control information and description information of the packet body, for example, information related to a transmitter, a receiver, and the time stamp. This is not limited in this embodiment of this disclosure. The packet body is main content of a packet, and includes to-be-transmitted data information. In this embodiment of this disclosure, the data information may be an instruction load, that is, the to-be-processed control instruction. The instruction load (or referred to as payload) is configured for identifying actual instruction content of the to-be-processed control instruction delivered by the server, for example, an actual instruction such as moving forward, moving backward, being static, or rotation. The instruction load may be self-defined by a control application according to a service implementation requirement. Referring to FIG. 3, FIG. 3 is a schematic diagram of a control instruction packet according to an embodiment of this disclosure. For a time stamp, refer to 301 in FIG. 3. In this embodiment of this disclosure, the time stamp may occupy eight bytes. For a to-be-processed control instruction, refer to 302 in FIG. 3. In this embodiment of this disclosure, a quantity of bytes of the to-be-processed control instruction is not limited, and may be determined according to an actual requirement, that is, N in FIG. 3 may be any value determined according to an actual requirement.

Content included in the control instruction packet is not limited in this embodiment of this disclosure, and specific content included in the control instruction packet, including a definition of a structure and a definition of a default value, may be extended according to a requirement.

In a possible implementation, the packet header of the control instruction packet may further include a type identifier, and the type identifier is configured for indicating whether the to-be-processed control instruction is a time sensitive control instruction. In this embodiment of this disclosure, the type identifier may occupy one byte. The type identifier may be represented in various forms, for example, may be a number or a symbol. In this embodiment of this disclosure, descriptions are provided mainly by using an example in which the type identifier is a numerical value. In this case, the type identifier may be referred to as a magic number, referring to 303 in FIG. 3.

In a possible implementation, the packet header of the control instruction packet may further include an instruction cycle. The instruction cycle represents a cycle in which the control application delivers a control instruction, that is, a time interval between two control instructions that are continuously delivered. The instruction cycle may occupy four bytes, as shown in 304 in FIG. 3. A unit of the instruction cycle is not limited in this embodiment of this disclosure, and may be, for example, second, millisecond, or microsecond. In this embodiment of this disclosure, the unit of the instruction cycle may be 100 microseconds.

In a possible implementation, the packet header of the control instruction packet may further include a reserved byte. The reserved byte occupies one byte, is mainly configured for extension, and has a default value of 0. For the reserved byte, refer to 305 in FIG. 3.

In a possible implementation, the packet header of the control instruction packet may further include a checksum. For distinguishing, the checksum carried in the packet header of the control instruction packet may be referred to as a first checksum. The first checksum occupies four bytes, referring to 306 in FIG. 3.

In a possible implementation, the network supporting the server in delivering the control instruction to the terminal may include a 5G network, a 4G network, a 3G network, or the like. In this embodiment of this disclosure, an example in which the network is the 5G network is mainly used for description. The 5G network may include a 5G public network and a 5G non-public network. The embodiments of this application are mainly described by using the 5G non-public network as an example. The 5G non-public network includes a 5G base station and a 5G core network. The 5G base station is a core device of the 5G network, provides wireless coverage, and implements wireless signal transmission between a wired communication network and a wireless terminal. An architecture and a form of the base station directly affect deployment of the 5G network. Because a higher frequency indicates greater attenuation in a signal transmission/broadcasting process, a base station density of the 5G network is generally higher. The 5G core network is further divided into a control panel device and a user plane function device.

Because there are many uncontrollable factors in a process of transmitting the control instruction through the network, a time sequence of the control instruction may be disordered. Once a time sequence of the control instructions delivered by the server is disordered, the terminal cannot work correctly. Therefore, to avoid this case, in this embodiment of this disclosure, the user plane function device is upgraded. Based on the existing user plane function device, a processing plug-in for the time sensitive control instruction is developed, so that strict time sequence control is performed on the time sensitive control instruction by performing operations S201 to S204. The user plane function device is a device close to the terminal. When the server and the terminal are far away, after the control instruction transmitted by the server to the terminal through the network passes a long transmission distance, even if the time sequence of the control instruction is disordered, a correct transmitting order of the control instruction can be obtained after processing by the user plane function device. Because the user plane function device is a device close to the terminal, the control instruction transmitted from the user plane function device and having a current time sequence also has a current time sequence when being transmitted to the terminal.

To control the terminal, a control application may be installed on the server. The control instruction delivered by the server may be specifically a control instruction delivered by the control application, and a control application delivering the time sensitive control instruction may be referred to as a time sensitive application. Based on the foregoing descriptions, for an architectural diagram of a software system of a data processing method provided in an embodiment of this disclosure, refer to FIG. 4. The software system includes a terminal 401, a user plane function device 402 in a network, and a time sensitive application 403 installed on a server. When a network communication technology is applied to an industrial Internet scenario, if the network communication technology is 5G, the terminal 401 may be a 5G industrial terminal. The time sensitive application 403 may transmit a to-be-processed control instruction to the terminal 401 through the network. After receiving a control instruction packet including the to-be-processed control instruction, the user plane function device 402 may process the to-be-processed control instruction to obtain a correct transmitting order of the to-be-processed control instruction, and then transmit the to-be-processed control instruction to the terminal 401 based on the transmitting order.

S202: If it is determined that the to-be-processed control instruction in the control instruction packet is the time sensitive control instruction, read the time stamp from the control instruction packet, and read the to-be-processed control instruction from the control instruction packet.

Although the server delivers the control instruction to control the terminal to work, the delivered control instruction is not necessarily the time sensitive control instruction. In this embodiment of this disclosure, operations S202 to S204 are performed only for the time sensitive control instruction. The time sensitive control instruction may include a control instruction that is used for cooperatively controlling, with one or more other control instructions, the terminal to complete a same/common task, and the terminal needs to respond to the time sensitive control instruction and the another control instruction based on a preset sequence when executing the task. In other words, for the time sensitive control instruction, the terminal needs to respond to the time sensitive control instruction strictly based on a response sequence that corresponds to the time sensitive control instruction in the corresponding task, and execute an operation instructed by the time sensitive control instruction. Otherwise, the terminal cannot successfully complete the task. In addition, because the another control instruction configured for controlling the terminal to complete the same task also needs to be responded to and executed strictly based on a corresponding response sequence, the another control instruction is essentially a time sensitive control instruction. For example, three time sensitive control instructions—A, B, and C—are necessary to collaboratively manage/control a task. The terminal must execute the corresponding tasks in a strict, predefined sequence: A, followed by B, and then C.

Therefore, after receiving the to-be-processed control instruction, the user plane function device may determine whether the to-be-processed control instruction is the time sensitive control instruction. If it is determined that the to-be-processed control instruction is the time sensitive control instruction, a correct transmitting order of the to-be-processed control instruction needs to be ensured. Therefore, the user plane function device may read the time stamp from the control instruction packet, and read the to-be-processed control instruction from the control instruction packet, so that the transmitting order of the to-be-processed control instruction can be determined based on the time stamp. If it is determined that the to-be-processed control instruction in the control instruction packet is a non-time sensitive control instruction, because a time sequence of the non-time sensitive control instruction does not affect normal work of the terminal, the user plane function device may skip, by default, performing operations S202 to S204 on the to-be-processed control instruction, but directly forward the to-be-processed control instruction to the terminal. The operation of reading the to-be-processed control instruction may be performed in S202, or may be performed in S203. This is not limited in this embodiment of this disclosure. A manner of reading the to-be-processed control instruction may be reading the to-be-processed control instruction from remaining bytes in the control instruction packet, where the remaining bytes may be bytes except bytes occupied by information in the packet header.

In this embodiment of this disclosure, there may be a plurality of manners of determining whether the to-be-processed control instruction is the time sensitive control instruction. A determining manner varies based on different determining bases.

In a possible implementation, the control instruction packet further includes the type identifier, and the type identifier may be description information of the packet body in the packet header. Based on the structure of the control instruction packet, for the type identifier, refer to 303 in FIG. 3. The type identifier is configured for indicating whether the to-be-processed control instruction is the time sensitive control instruction. Therefore, the type identifier may be used as a determining basis. Whether the to-be-processed control instruction is a target control instruction is determined based on the type identifier. In this case, a manner of determining whether the to-be-processed control instruction in the control instruction packet is the time sensitive control instruction may be obtaining the type identifier from the control instruction packet, to determine, based on the type identifier, whether the to-be-processed control instruction is the time sensitive control instruction.

For example, when the type identifier is a magic number, a value corresponding to the magic number when the to-be-processed control instruction is the time sensitive control instruction is different from a value corresponding to the magic number when the to-be-processed control instruction is the non-time sensitive control instruction. Setting of the value is not limited in this embodiment of this disclosure. For example, when the to-be-processed control instruction is the time sensitive control instruction, the value of the magic number may be defined as 12, and when the to-be-processed control instruction is the non-time sensitive control instruction, the value of the magic number may be defined as a value other than 12.

The type identifier may directly indicate whether the to-be-processed control instruction is the time sensitive control instruction. Therefore, whether the to-be-processed control instruction is the time sensitive control instruction may be determined more simply and directly by using the type identifier as the determining basis.

The control instruction packet is obtained through encapsulation by adding the packet header to the to-be-processed control instruction. In a process of obtaining the to-be-processed control instruction, the control instruction packet needs to be decapsulated. Decapsulation is performed layer by layer. For example, the packet header may be removed first to obtain an actual load of the control instruction packet. The actual load is all content included in the control instruction packet, for example, necessary control information in the packet header, description information of the packet body, and the to-be-processed control instruction in the packet body. Then, specific content such as the type identifier can be read from the actual load.

In this embodiment of this disclosure, the structure of the control instruction packet for transmitting the time sensitive control instruction is defined, and there is a corresponding data length requirement on content included in the structure. Therefore, the control instruction packet for transmitting the time sensitive control instruction at least needs to satisfy the data length requirement. Based on this, before obtaining the type identifier from the control instruction packet, the user plane function device may first obtain a packet length of the control instruction packet, and perform initial determining on the to-be-processed control instruction based on the packet length. The packet length may represent a quantity of bytes of the actual load. If it is determined that the packet length is greater than a data length threshold, it indicates that the packet length of the control instruction packet reaches the data length requirement on the transmission of the time sensitive control instruction, and the to-be-processed control instruction in the control instruction packet may be the time sensitive control instruction. Therefore, the operation of obtaining the type identifier from the control instruction packet may be performed, to further determine whether the to-be-processed control instruction is the time sensitive control instruction. If it is determined that the packet length is less than or equal to the data length threshold, it indicates that the packet length of the control instruction packet does not reach the data length requirement on the transmission of the time sensitive control instruction, and the to-be-processed control instruction in the control instruction packet is the non-time sensitive control instruction. Because the time sequence of the non-time sensitive control instruction does not affect normal work of the terminal, the user plane function device may skip, by default, performing operations S202 to S204 on the to-be-processed control instruction, but directly forward the to-be-processed control instruction to the terminal.

The packet length and the data length threshold may each be indicated by using a quantity of bytes. The data length threshold is set based on a data length of all information included in the packet header in the control instruction packet. For example, the packet header includes the time stamp and the type identifier, the time stamp occupies eight bytes, and the type identifier occupies one byte. In this case, the data length threshold may be nine bytes. Certainly, if the packet header further includes other information, assuming that the information occupies nine bytes, the data length threshold may be 18 bytes. In addition to the packet header, the control instruction packet further includes the packet body, and the to-be-processed control instruction in the packet body also occupies a certain data length. Therefore, if the to-be-processed control instruction in the control instruction packet is the time sensitive control instruction, the packet length of the control instruction packet needs to be greater than the data length threshold.

In this embodiment of this disclosure, whether the to-be-processed control instruction is the time sensitive control instruction is determined first based on the packet length, so that determining is first determined in a perspective of the whole packet. In this way, if it is determined, in the perspective of the whole packet, that the to-be-processed control instruction is the time sensitive control instruction, the type identifier does not need to be further obtained, and whether the to-be-processed control instruction is the time sensitive control instruction does not need to be determined based on the type identifier, thereby avoiding unnecessary operations, reducing resource consumption, and improving determining efficiency. However, if it is determined, in the perspective of the whole packet, that the to-be-processed control instruction may be the time sensitive control instruction, whether the to-be-processed control instruction is the time sensitive control instruction may be further determined with reference to the type identifier, and whether the to-be-processed control instruction is the time sensitive control instruction is determined with reference to the packet length and the type identifier, so that determining accuracy can be improved.

When whether the to-be-processed control instruction is the time sensitive control instruction is determined based on the type identifier, a manner of determining, based on the type identifier, whether the to-be-processed control instruction is the time sensitive control instruction may also vary based on different defined structures of the control instruction packet. If the control instruction packet does not include other information that can be configured for determining whether the to-be-processed control instruction is the time sensitive control instruction, determining may be performed only based on the type identifier. In this case, the manner of determining, based on the type identifier, whether the to-be-processed control instruction is the time sensitive control instruction may be: if the type identifier is a time sensitive identifier, determining that the to-be-processed control instruction is the time sensitive control instruction. The time sensitive identifier may vary based on different representation forms of the type identifier. When the type identifier is a magic number, the time sensitive identifier may be a specific value, for example, 12. In this way, whether the to-be-processed instruction carried in the control instruction packet is the time sensitive control instruction is determined directly based on the type identifier in the control instruction packet, so that a type of the control instruction can be efficiently determined, and consumption of related processing resources can be reduced. In some implementations, the to-be-processed instruction may specifically apply to control instruction.

In some cases, based on the foregoing defined structure of the control instruction packet, the control instruction packet may further include a first checksum. The first checksum is configured for determining whether the to-be-processed control instruction included in the current control instruction packet is the time sensitive control instruction. A manner of calculating the first checksum is adding, based on a plurality of formed unsigned 16-bit integers, all bytes before the first checksum in the control instruction packet, to obtain a 32-bit unsigned integer through calculation as a checksum. For example, when the control instruction packet includes the magic number, the reserved byte, the instruction cycle, the time stamp, and the first checksum, all bytes located before the first checksum may be 14 bytes, and seven unsigned 16-bit integers may be added to obtain a 32-bit unsigned integer through calculation. The first checksum carried in the control instruction packet is pre-calculated and added to the control instruction packet based on the structure of the control instruction packet when the to-be-processed control instruction is the time sensitive control instruction.

In this case, when whether the to-be-processed control instruction is the time sensitive control instruction is determined based on the type identifier, the to-be-processed control instruction may be determined collaboratively with reference to the type identifier and the first checksum. Specifically, the manner of determining, based on the type identifier, whether the to-be-processed control instruction is the time sensitive control instruction may be: if the type identifier is the time sensitive identifier, obtaining the first checksum from the control instruction packet, and obtaining a plurality of bytes located before the first checksum from the to-be-processed instruction packet. Then, checksum calculation is performed on the plurality of bytes, to obtain a second checksum. Consistency comparison is performed between the first checksum and the second checksum, to obtain a comparison result, and then whether the to-be-processed control instruction is the time sensitive control instruction is determined based on the comparison result. If the comparison result indicates that the first checksum is consistent with the second checksum, it is determined that the to-be-processed control instruction is the time sensitive control instruction. If the comparison result indicates that the first checksum is inconsistent with the second checksum, it is determined that the to-be-processed control instruction is the non-time sensitive control instruction.

For a specific implementation of calculating the checksum, refer to the calculation manner described above. An example in which the control instruction packet includes the magic number, the reserved byte, the instruction cycle, the time stamp, and the first checksum is used. First 18 bytes (where the first 18 bytes are all bytes corresponding to the magic number, the reserved byte, the instruction cycle, the time stamp, and the first checksum) of the instruction load in the control instruction packet are read, and first 14 bytes (where the first 14 bytes are all bytes corresponding to the magic number, the reserved byte, the instruction cycle, and the time stamp, that is, bytes before the first checksum) are added based on the seven unsigned 16-bit integers, to obtain the second checksum of the 32-bit unsigned integer through calculation. After the second checksum is obtained through the checksum calculation, the second checksum may be compared with the 32-bit unsigned integer (that is, the first checksum) represented by the last four bytes in the read 18 bytes. If values are not equal, that is, the first checksum is inconsistent with the second checksum, it indicates that the to-be-processed control instruction is the non-time sensitive control instruction, and the user plane function device may directly forward the to-be-processed control instruction to the terminal by default. If the values are equal, that is, the first checksum is consistent with the second checksum, it indicates that the to-be-processed control instruction is the time sensitive control instruction.

In the foregoing manner, whether the to-be-processed control instruction is the time sensitive control instruction is determined with reference to the type identifier and the first checksum, to avoid a mis-determining caused by coincidence when the type identifier is exactly the time sensitive identifier, thereby further improving accuracy of determining whether the to-be-processed control instruction is the time sensitive control instruction.

S203: Determine a transmitting order of the to-be-processed control instruction based on the time stamp.

After the time stamp is obtained, the transmitting order of the to-be-processed control instruction may be determined. For the time sensitive control instruction, a plurality of time sensitive control instructions configured for controlling the terminal to complete the task have a specific sequence. Therefore, for each time sensitive control instruction, the user plane function device needs to determine an accurate transmitting order of the time sensitive control instruction. When the transmitting order of each time sensitive control instruction is accurate, the transmitting sequence of the plurality of time sensitive control instructions is accurate, so that normal work of the terminal can be ensured.

In this embodiment of this disclosure, a main objective of determining the transmitting order of the to-be-processed control instruction is to control the transmitting sequence of the plurality of time sensitive control instructions, so that the plurality of time sensitive control instructions are transmitted based on a preset sequence. The preset sequence may be a transmitting sequence of the plurality of time sensitive control instructions when it is ensured that the plurality of time sensitive control instructions can control the terminal to work normally (that is, control the terminal to execute the task normally). Because a message queue has a sequence, storage positions of a plurality of messages in the message queue may represent a transmitting sequence of the plurality of messages. Based on this, a manner of determining the transmitting order of the to-be-processed control instruction based on the time stamp may be: determining a target position of the to-be-processed control instruction in the message queue based on the time stamp, and buffering the to-be-processed control instruction at the target position. The message queue is configured for buffering a plurality of received control instructions that are configured for controlling the terminal to execute the task, the target position being configured for indicating a transmitting order of the to-be-processed control instruction in the plurality of control instructions, and the plurality of control instructions being configured for controlling the terminal to complete the task based on the preset sequence. When the message queue is configured for storing the time sensitive control instruction, the time sensitive control instruction is used as a message in the message queue, and the target position is a storage position of the time sensitive control instruction in the message queue.

There may be a plurality of types of the message queues. For example, the message queue may be a linear queue or a circular queue. In this embodiment of this disclosure, descriptions are provided mainly by using an example in which the message queue is the circular queue. The circular queue is a special message queue in which some restrictions are added to the linear queue, so that the message queue may be circularly used in a storage space of a fixed size. An advantage of the circular queue is that, when the circular queue is full, a new element may be continuously stored by using an element covering a head of the circular queue. In this way, the circular queue has a capability of being circularly used to some extent, thereby saving the storage space.

In some cases, the server may continuously deliver control instructions to the terminal based on a specific frequency (or cycle). In this case, the control instruction packet further includes the instruction cycle, and a manner of determining the target position of the to-be-processed control instruction in the message queue based on the time stamp may be: obtaining the instruction cycle from the control instruction packet, and determining the target position of the to-be-processed control instruction in the message queue based on the time stamp and the instruction cycle.

For example, a time stamp at which the server transmits a first control instruction is denoted as 0, and the instruction cycle is 100 microseconds. In this case, a time stamp at which the server transmits a second control instruction may be denoted as 100 microseconds, a time stamp at which the server transmits a third control instruction may be denoted as 200 microseconds, a time stamp at which the server transmits a fourth control instruction may be denoted as 300 microseconds, and the rest is deduced by analogy. In this way, if the time stamp of the to-be-processed control instruction is 200 milliseconds, and it can be learned with reference to the instruction cycle that the to-be-processed control instruction is the third control instruction, and the target position of the to-be-processed control instruction in the message queue may be a third position in the message queue. For example, the first control instruction is already buffered in the message queue. In this case, it may be determined, with reference to the instruction cycle of 100 microseconds and the time stamp of 200 microseconds, that the target position of the to-be-processed control instruction in the message queue is spaced apart from the first control instruction by one position.

In the foregoing manner, the transmitting order of the to-be-processed control instruction is determined with reference to the instruction cycle and the time stamp, so that the accurate position of the to-be-processed control instruction in the message queue can be directly and quickly determined, thereby facilitating subsequently transmitting the to-be-processed control instruction to the terminal based on the correct transmitting order based on the position of the to-be-processed control instruction in the message queue.

S204: Transmit the to-be-processed control instruction to the terminal based on the transmitting order, the terminal being configured to perform a corresponding operation in the task in response to the to-be-processed control instruction.

After determining the transmitting order of the to-be-processed control instruction, the user plane function device may transmit the to-be-processed control instruction to the terminal based on the transmitting order, so that the terminal may perform the corresponding operation in the task in response to the to-be-processed control instruction.

When an implementation of S203 is determining the target position of the to-be-processed control instruction in the message queue based on the time stamp, and buffering the to-be-processed control instruction at the target position, an implementation of S204 may be reading the to-be-processed control instruction from the target position in the message queue, and transmitting the to-be-processed control instruction to the terminal.

After determining the transmitting order, the user plane function device determines a sequence number of the to-be-processed control instruction in the plurality of control instructions configured for controlling the terminal to execute the same task. However, an occasion of transmitting the to-be-processed control instruction is not limited in this embodiment of this disclosure. In a possible implementation, the occasion of transmitting the to-be-processed control instruction may be transmitting the to-be-processed control instruction immediately, after the transmitting order is determined, once it is determined that a control instruction previous to the to-be-processed control instruction is already transmitted.

In another possible implementation, the server may periodically transmit the control instruction to the terminal based on the instruction cycle. In this case, the occasion of transmitting the to-be-processed control instruction may be determined based on the instruction cycle. To automatically transmit the to-be-processed control instruction based on the instruction cycle, in this embodiment of this disclosure, an instruction transmitting timer may be started, and a trigger time interval of the instruction transmitting timer is the instruction cycle, that is, the trigger time interval is set to a value of the instruction cycle. In this case, a manner of reading the to-be-processed control instruction from the target position in the message queue and transmitting the to-be-processed control instruction to the terminal may be: when the instruction transmitting timer reaches a transmitting time point based on the trigger time interval, if it is determined that the transmitting time point corresponds to the to-be-processed control instruction, reading the to-be-processed control instruction from the message queue, and transmitting the to-be-processed control instruction to the terminal.

The instruction transmitting timer is used, and the trigger time interval of the instruction transmitting timer is set to the value of the instruction cycle, so that the to-be-processed control instruction can be automatically transmitted based on the instruction cycle, thereby implementing automatic processing.

In a process in which the server transmits the to-be-processed control instruction to the terminal through the network, to control the plurality of control instructions (mainly the time sensitive control instruction) to be transmitted based on the preset sequence, strict time sequence control is implemented on the time sensitive control instruction through operations S201 to S204. However, in a process of implementing time sequence control, the time stamp at which the server transmits the to-be-processed control instruction is determined based on a clock on the server, and time at which the user plane function device transmits the to-be-processed control instruction is determined based on a clock on the user plane function device. To ensure that the user plane function device can determine the transmitting order based on the time stamp, and transmit the to-be-processed control instruction on time based on the transmitting order, time consistency between the server and the user plane function device needs to be ensured. Therefore, a clock synchronization device may be separately deployed on the server and the user plane function device, and the clock synchronization device is configured to control the time consistency between the server and the user plane function device.

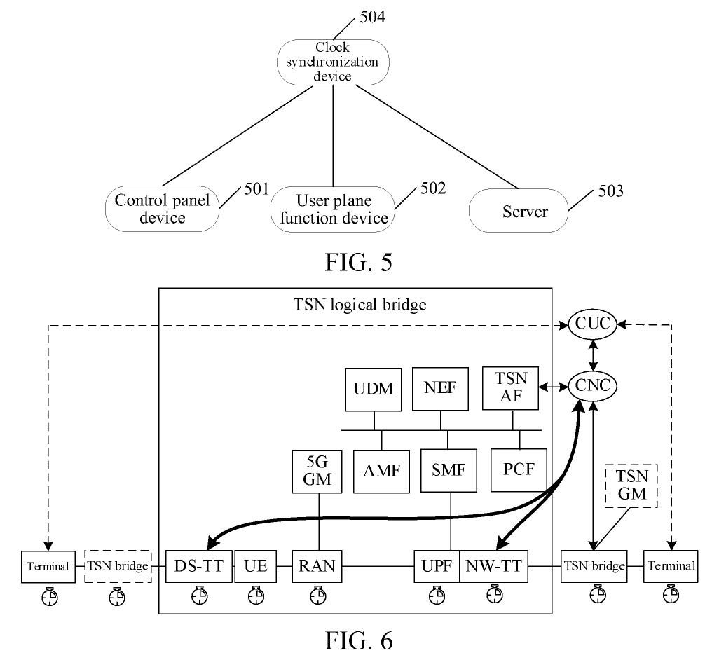

The clock synchronization device may be a precise time protocol (PTP)-based clock synchronization device, and specifically, may be a PTP clock synchronization device based on the IEEE 1588 specification, so that strict time consistency between the server and the user plane function device in the entire scenario can be achieved, and nanosecond-level synchronization precision is achieved. As shown in FIG. 5, a 5G non-public network is used as an example in FIG. 5. The 5G non-public network includes a 5G base station and a 5G core network, and the 5G core network is further divided into a control panel device (for example, shown in 501 in FIG. 5) and a user plane function device (for example, shown in 502 in FIG. 5). In addition, FIG. 5 further includes a server (for example, shown in 503 in FIG. 5) that transmits a to-be-processed control instruction. In this embodiment of this disclosure, a clock synchronization device 504 may be deployed on each of the control panel device 501, the user plane function device 502, and the server 503.

In the foregoing manner, time consistency between the server and the user plane function device is controlled through the clock synchronization device, thereby ensuring accuracy of controlling a time sequence of a time sensitive control instruction.

The data processing method provided in this embodiment of this disclosure is compared with a data processing method provided in the related technology below. In the related technology, a time sensitive network (TSN) technology is used to perform time sequence control on the time sensitive control instruction. As a technology leading innovation in the network communication field, the TSN technology includes a plurality of key protocol standards, including IEEE802.1AS, IEEE802.1Qbv, and the like. These protocol standards are not only cornerstones of the TSN technology, but also key elements for implementing highly reliable and deterministic transmission. The IEEE802.1AS protocol is an important component of the TSN technology, and defines a precise clock synchronization mechanism, so that devices in the network can synchronize under microsecond-level time precision. This is very important to some application scenarios with an extremely high time requirement, such as cooperative operations in industrial automation, precise control in a vehicle network, and audio and video transmission.

An example in which the network is the 5G network is used. To support integration of the 5G network and the TSN, a time sensitive communication (TSC) function may be added. As shown in FIG. 6, a 5G network is a TSN virtual bridge, a device-side TSN translator (DS-TT) module is added to a UE side, and a network-side TSN translator (NW-TT) is added to a user plane function (UPF) side. The two TSN translators connect the 5G network to the TSN network. The 5G TSN network has a full central model network architecture defined by the IEEE 802.1Qcc protocol. Therefore, interaction between a TSN application function (AF) network element and a centralized network controller (CNC) is added to a policy control function (PCF) in the 5G network, so that the CNC configures and manages a 5G TSN logical bridge. The network architecture shown in FIG. 6 may further include an access and mobility management function (AMF), a centralized user controller (CUC), a grand master (GM), a network exposure function (NEF), a radio access network (RAN), a session management function (SMF), a unified data management (UDM), and the like.

Although the data processing method provided in the related technology can implement time sequence control, the TSN technology is not mature, a combination of the 5G network and the TSN technology is excessively complex, and version development of a plurality of 5G network elements is involved. A problem of network compatibility needs to be considered. In addition, the 5G network, the 5G terminal, and the entire network architecture need to be upgraded. As a result, high costs are caused to current network use. However, in the method provided in this embodiment of this disclosure, a mature commercial PTP-based clock synchronization device is introduced, to ensure clock synchronization between the user plane function device and the server in the network. In addition, the industrial Internet terminal does not need to be upgraded, and only software of a single network element, that is, the user plane function device, of the network needs to be upgraded, so that the time sensitive control instruction delivered by the server is transmitted to the terminal according to strict time consistency. The entire solution is simple and convenient to implement, has clear cost advantages, and can be widely applied to application scenarios related to a time sensitive application in the industrial Internet.

It can be seen from the foregoing technical solutions that, in a process in which the server transmits the control instruction to the terminal through the network, the user plane function device in the network may obtain the control instruction packet transmitted by the server, the control instruction packet including the to-be-processed control instruction and the time stamp at which the server transmits the to-be-processed control instruction. If it is determined that the to-be-processed control instruction in the control instruction packet is the time sensitive control instruction, it indicates that the to-be-processed control instruction needs to be transmitted based on a specific transmitting order, to ensure that the terminal is controlled, through the to-be-processed control instruction, to complete the task correctly. The time stamp can represent transmitting time at which the server transmits the to-be-processed control instruction. Therefore, in a process in which the to-be-processed control instruction is transmitted to the terminal through the network, to avoid a disordered time sequence of the to-be-processed control instruction caused by uncontrollable factors in the transmission process, the time stamp and the to-be-processed control instruction may be read from the control instruction packet, to accurately determine the transmitting order of the to-be-processed control instruction based on the time stamp. Then, the to-be-processed control instruction may be transmitted to the terminal based on the transmitting order, the terminal being configured to perform a corresponding operation in the task in response to the to-be-processed control instruction. For each time sensitive control instruction, an accurate transmitting order of the time sensitive control instruction is determined before the time sensitive control instruction is transmitted to the terminal, and the time sensitive control instruction is transmitted based on the transmitting order. Therefore, for a plurality of control instructions, a transmitting sequence of the plurality of control instructions is also consistent with a preset sequence configured to ensure successful task completion, that is, the transmitting sequence is correct. In this way, even if a time sequence is disordered in the transmission process, the user plane function device can still determine a correct transmitting order, to ensure that the plurality of control instructions, based on which the terminal is controlled to execute the task, can be transmitted to the terminal strictly based on the correct transmitting sequence, thereby ensuring that the terminal can work correctly.

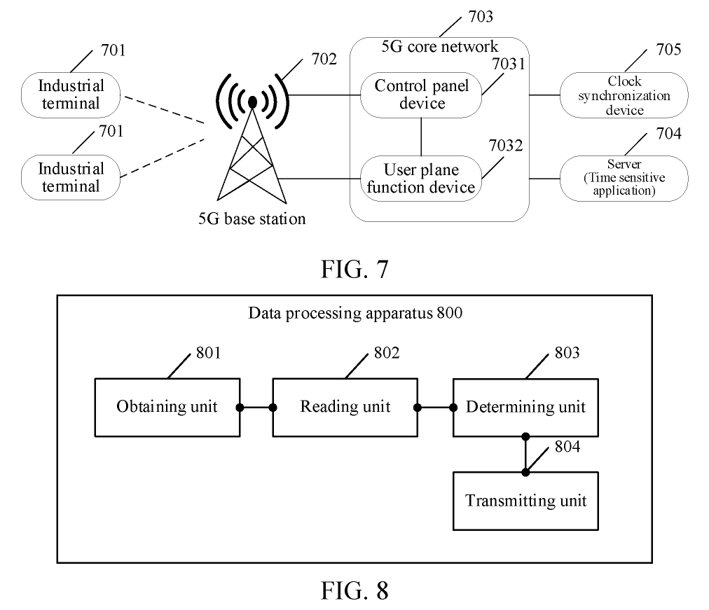

Next, the data processing method provided in the embodiments of this application is described with reference to the actual application scenario. An example of a product related to a 5G network and an industrial Internet application is used in the actual application scenario. A mainly faced application scenario is a solution of a time sensitive application in an industrial Internet scenario based on a 5G non-public network, and an entire system architecture is shown in FIG. 7. The entire system architecture includes a plurality of industrial terminals 701, a 5G base station 702, a 5G core network 703, a server 704, and a clock synchronization device 705. The 5G core network 703 includes a control panel device 7031 and a user plane function device 7032, and a time sensitive application is installed on the server 704.

The plurality of industrial terminals 701 are 5G terminal devices, for example, industrial robots, that perform different actions by receiving different time sensitive control instructions delivered by the remote server 704. The server may indicate that the industrial robot needs to move forward, move backward, stop, or the like.

The clock synchronization device is a PTP-based clock synchronization device, is a mature commercial device, and is mainly configured to implement precise time synchronization between the server and the device (for example, the control panel device 7031 and the user plane function device 7032) included in the 5G core network.

The time sensitive application is an industrial Internet application deployed on the server 704, and is responsible for generating a control instruction of the industrial terminal according to a service logic requirement, and then delivering the control instruction to the industrial terminal through the user plane function device 7032 of the 5G network.

The structure of the control instruction packet shown in FIG. 3 is used as an example, and the user plane function device may perform the following operations to control a time sequence of the time sensitive control instruction.

Operation 1: A time sensitive application usually periodically transmits a control instruction to an industrial terminal. In this embodiment of this disclosure, the time sensitive application transmits a control instruction packet carrying a time sensitive control instruction to a user plane function device.

Operation 2: After receiving the control instruction packet, the user plane function device first removes a packet header of a four-layer (TCP or UDP) packet, to obtain an actual load. If a quantity of bytes (that is, a packet length) of the actual load is less than 18 bytes, it indicates that a to-be-processed control instruction in the control instruction packet is a non-time sensitive control instruction, and the user plane function device directly forwards and processes the to-be-processed control instruction in a default manner. If a quantity of bytes of the actual load is greater than 18 bytes, operation 3 is performed. Note that in some implementations, the actual load refers to the payload of a packet, which typically only includes relevant user information or message content, distinct from header information used for control purposes (e.g., routing and delivery). For example, the payload may only include the content of the control instruction itself.

Operation 3: Continue to determine whether the first byte is equal to a magic number 12. If the first byte is not equal to the magic number 12, it indicates that the to-be-processed control instruction in the control instruction packet is the non-time sensitive control instruction, and the user plane function device directly forwards and processes the to-be-processed control instruction in a default manner. If the first byte is equal to the magic number 12, operation 4 is performed.

Operation 4: Read the first 18 bytes of the actual load, add the first 14 bytes based on seven unsigned 16-bit integers, and compare a second checksum of a 32-bit unsigned integer obtained through calculation with a 32-bit unsigned integer (that is, a first checksum) indicated by last four bytes in the first 18 bytes. If values of the first checksum and the second checksum are not equal, it indicates that the to-be-processed control instruction in the control instruction packet is a non-time sensitive control instruction, and the user plane function device directly forwards and processes the to-be-processed control instruction in a default manner. If (or only if) values of the first checksum and the second checksum are equal, operation 5 is performed.

Operation 5: Determine that the to-be-processed control instruction is the time sensitive control instruction, first read a time stamp and an instruction cycle from first 14 bytes, and start an instruction transmitting timer, a trigger time interval of the instruction transmitting timer being set to a value of the instruction cycle. Then, the user plane function device reads remaining bytes in the control instruction packet, that is, an actual instruction load, extracts the instruction load, and buffers the to-be-processed control instruction at a target position in a circular queue based on the time stamp and the instruction cycle. When the instruction transmitting timer reaches a transmitting time point based on the trigger time interval, the to-be-processed control instruction buffered at the target position is read from the circular queue, and the to-be-processed control instruction is transmitted to the industrial terminal.

Based on the implementations provided in the foregoing aspects, this application may be further combined to provide more implementations.

Based on the data processing method provided in the embodiment corresponding to FIG. 2, an embodiment of this disclosure further provides a data processing apparatus 800. Referring to FIG. 8, the data processing apparatus 800 includes an obtaining unit 801, a reading unit 802, a determining unit 803, and a transmitting unit 804.

The obtaining unit 801 is configured to obtain a control instruction packet transmitted by a server, the control instruction packet including a to-be-processed control instruction and a time stamp at which the server transmits the to-be-processed control instruction.

The reading unit 802 is configured to: if it is determined that the to-be-processed control instruction in the control instruction packet is a time sensitive control instruction, read the time stamp from the control instruction packet, and read the to-be-processed control instruction from the control instruction packet, the time sensitive control instruction being configured for cooperatively controlling, with another control instruction, a terminal to complete the same task, and the terminal needing to respond to the time sensitive control instruction and the another control instruction based on a preset sequence when executing the task.

The determining unit 803 is configured to determine a transmitting order of the to-be-processed control instruction based on the time stamp.

The transmitting unit 804 is configured to transmit the to-be-processed control instruction to the terminal based on the transmitting order, the terminal being configured to perform a corresponding operation in the task in response to the to-be-processed control instruction.

In a possible implementation, the control instruction packet further includes a type identifier, the type identifier is configured for indicating whether the to-be-processed control instruction is the time sensitive control instruction, and the reading unit 802 is configured to determine whether the to-be-processed control instruction in the control instruction packet is the time sensitive control instruction in the following manners:

obtaining the type identifier from the control instruction packet; and

determining, based on the type identifier, whether the to-be-processed control instruction is the time sensitive control instruction.

In a possible implementation, the obtaining unit 801 is further configured to:

obtain a packet length of the control instruction packet; and

the reading unit 802 is further configured to: before the obtaining the type identifier from the control instruction packet, if it is determined that the packet length is greater than a data length threshold, trigger the reading unit 802 to perform the operation of obtaining the type identifier from the control instruction packet.

In a possible implementation, the reading unit 802 is specifically configured to:

determine that the to-be-processed control instruction is the time sensitive control instruction if the type identifier is a time sensitive identifier.

In a possible implementation, the control instruction packet further includes a first checksum, and the reading unit 802 is specifically configured to:

if the type identifier is a time sensitive identifier, obtain the first checksum from the control instruction packet, and obtain a plurality of bytes located before the first checksum from the to-be-processed instruction packet;

perform checksum calculation on the plurality of bytes, to obtain a second checksum;

perform consistency comparison between the first checksum and the second checksum, to obtain a comparison result; and

determine that the to-be-processed control instruction is the time sensitive control instruction if the comparison result indicates that the first checksum is consistent with the second checksum.

In a possible implementation, the determining unit 803 is specifically configured to:

determine a target position of the to-be-processed control instruction in a message queue based on the time stamp, and buffer the to-be-processed control instruction at the target position, the message queue being configured for buffering a plurality of received control instructions that are configured for controlling the terminal to execute the task, and the target position being configured for indicating a transmitting order of the to-be-processed control instruction in the plurality of control instructions.

The transmitting unit 804 is configured to read the to-be-processed control instruction from the target position in the message queue, and transmit the to-be-processed control instruction to the terminal.

In a possible implementation, the control instruction packet further includes an instruction cycle, and the determining unit 803 is specifically configured to:

obtain the instruction cycle from the control instruction packet; and

determine the target position of the to-be-processed control instruction in the message queue based on the time stamp and the instruction cycle.

In a possible implementation, the apparatus further includes a starting unit.

The starting unit is configured to start an instruction transmitting timer, a trigger time interval of the instruction transmitting timer being the instruction cycle; and

the transmitting unit 804 is specifically configured to: when the instruction transmitting timer reaches a transmitting time point based on the trigger time interval, if it is determined that the transmitting time point corresponds to the to-be-processed control instruction, read the to-be-processed control instruction from the target position in the message queue, and transmit the to-be-processed control instruction to the terminal.

In a possible implementation, the apparatus is deployed on a user plane function device in a network, the server transmits the to-be-processed control instruction to the terminal through the network, a clock synchronization device is separately deployed on the server and the user plane function device, and the clock synchronization device is configured to control time consistency between the server and the user plane function device.

In a possible implementation, the transmitting unit 804 is further configured to:

forward the to-be-processed control instruction to the terminal if it is determined that the to-be-processed control instruction in the control instruction packet is not the time sensitive control instruction.

It can be seen from the foregoing technical solutions that, in a process in which the server transmits the control instruction to the terminal through the network, the user plane function device in the network may obtain the control instruction packet transmitted by the server, the control instruction packet including the to-be-processed control instruction and the time stamp at which the server transmits the to-be-processed control instruction. If it is determined that the to-be-processed control instruction in the control instruction packet is the time sensitive control instruction, it indicates that the to-be-processed control instruction needs to be transmitted based on a specific transmitting order, to ensure that the terminal is controlled, through the to-be-processed control instruction, to complete the task correctly. The time stamp can represent transmitting time at which the server transmits the to-be-processed control instruction. Therefore, in a process in which the to-be-processed control instruction is transmitted to the terminal through the network, to avoid a disordered time sequence of the to-be-processed control instruction caused by uncontrollable factors in the transmission process, the time stamp and the to-be-processed control instruction may be read from the control instruction packet, to accurately determine the transmitting order of the to-be-processed control instruction based on the time stamp. Then, the to-be-processed control instruction may be transmitted to the terminal based on the transmitting order, the terminal being configured to perform a corresponding operation in the task in response to the to-be-processed control instruction. For each time sensitive control instruction, an accurate transmitting order of the time sensitive control instruction is determined before the time sensitive control instruction is transmitted to the terminal, and the time sensitive control instruction is transmitted based on the transmitting order. Therefore, for a plurality of control instructions, a transmitting sequence of the plurality of control instructions is also consistent with a preset sequence configured to ensure successful task completion, that is, the transmitting sequence is correct. In this way, even if a time sequence is disordered in the transmission process, the user plane function device can still determine a correct transmitting order, to ensure that the plurality of control instructions, based on which the terminal is controlled to execute the task, can be transmitted to the terminal strictly based on the correct transmitting sequence, thereby ensuring that the terminal can work correctly.

An embodiment of this disclosure further provides a computer device. The computer device may be a terminal. An example in which the terminal is a smartphone is used.

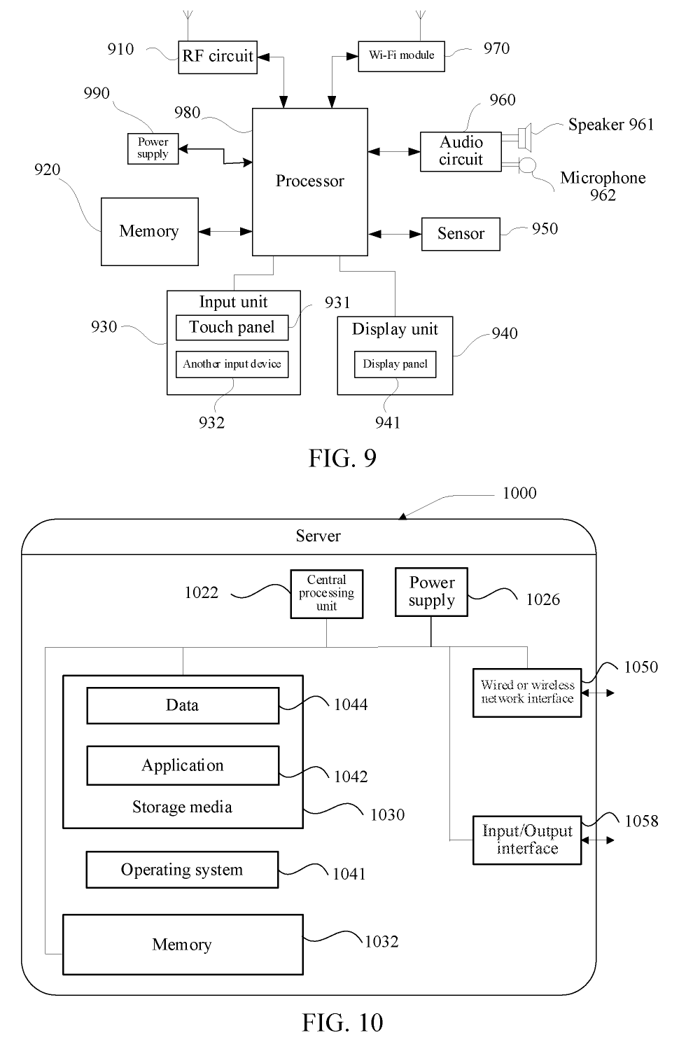

FIG. 9 is a block diagram of a partial structure of a smartphone according to an embodiment of this disclosure. Referring to FIG. 9, the smartphone includes components such as a radio frequency (RF) circuit 910, a memory 920, an input unit 930, a display unit 940, a sensor 950, an audio circuit 960, a wireless fidelity (Wi-Fi) module 970, a processor 980, and a power supply 990. The input unit 930 may include a touch panel 931 and another input device 932, the display unit 940 may include a display panel 941, and the audio circuit 960 may include a speaker 961 and a microphone 962. The structure of the smartphone shown in FIG. 9 does not constitute a limitation to the smart phone, and the smart phone may include more components or fewer components than those shown in the figure, or some components may be combined, or a different component deployment may be used.

The memory 920 may be configured to store a software program and a module. The processor 980 executes various functional applications and data processing of the smartphone by running the software program and the module stored in the memory 920. The memory 920 may mainly include a program storage area and a data storage area. The program storage area may store an operating system, an application required by at least one function (such as a sound playback function and an image playback function), or the like. The data storage area may store data (such as audio data and a phone book) created based on use of the smartphone, or the like. In addition, the memory 920 may include a high-speed random access memory, and may further include a non-volatile memory, such as at least one magnetic disk storage device, a flash storage device, or another volatile solid-state storage device.

The processor 980 is a control center of the smartphone, is connected to various parts of the entire smartphone by using various interfaces and lines, and executes various functions of the smartphone and processes data by running or executing a software program and/or a module stored in the memory 920 and invoking data stored in the memory 920. In some embodiments, the processor 980 may include one or more processing units. Preferably, the processor 980 may integrate an application processor and a modem processor. The application processor mainly processes an operating system, a user interface, an application, and the like. The modem processor mainly processes wireless communication. The modem processor may alternatively not be integrated in the processor 980.

In this embodiment, operations that need to be performed by the processor 980 in the smartphone may be implemented based on the structure shown in FIG. 9.

The computer device provided in this embodiment of this disclosure may alternatively be a server, and the server may be used as a user plane function device. Referring to FIG. 10, FIG. 10 is a structural diagram of a server 1000 according to an embodiment of this disclosure. The server 1000 may vary greatly because of different configurations or performance, and may include one or more processors, for example, a central processing unit (CPU) 1022, a memory 1032, and one or more storage media 1030 (for example, one or more mass storage devices) that store an application program 1042 or data 1044. The memory 1032 and the storage medium 1030 may be temporarily stored or permanently stored (e.g., non-transitory). The program stored in the storage medium 1030 may include one or more modules (not marked in the figure), and each module may include a series of instruction operations on the server. Further, the central processing unit 1022 may be configured to communicate with the storage medium 1030, and execute a series of instructions and operations in the storage medium 1030 on the server 1000.

The server 1000 may further include one or more power supplies 1026, one or more wired or wireless network interfaces 1050, one or more input/output interfaces 1058, and/or one or more operating systems 1041, such as Windows ServerTM, Mac OS XTM, UnixTM, LinuxTM, and FreeBSDTM.

In this embodiment, operations that need to be performed by the CPU 1022 in the server 1000 may be implemented based on the structure shown in FIG. 10.

According to one aspect of this application, a computer-readable storage medium is provided (e.g., non-transitory storage medium), the computer-readable storage medium being configured to store a computer program, and the computer program being configured to perform the data processing method according to the foregoing embodiments.

According to an aspect of this application, a computer program product is provided. The computer program product includes a computer program, a computer-readable storage medium (e.g., non-transitory storage medium) having the computer program stored therein. The processor of the computer device reads the computer program from the computer-readable storage medium, and the processor executes the computer program, so that the computer device performs the methods provided in the various optional implementations of the foregoing embodiments.

Descriptions of processes or structures corresponding to the foregoing accompanying drawings have respective focuses. For a part that is not described in detail in a process or structure, refer to related descriptions of another process or structure.

The specification and terms "first", "second", "third", "fourth", and the like (if any) of the foregoing accompanying drawings of this application are used to distinguish similar objects, but are unnecessarily used to describe a specific sequence or order. The data used in such a way is interchangeable in proper circumstances, so that the embodiments of this application described herein can be implemented, for example, in other sequences than the sequence illustrated or described herein. In addition, the terms "comprise", "include", and any other variants thereof mean to cover the non-exclusive inclusion. For example, a process, method, system, product, or device that includes a list of operations or units is not necessarily limited to those operations or units that are clearly listed, but may include other operations or units not expressly listed or inherent to such a process, method, system, product, or device.

In the embodiments provided in this application, the disclosed system, apparatus, and method may be implemented in other manners. For example, the described apparatus embodiment is merely an example. For example, unit division is merely logical function division, and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate components may or may not be physically separate, and components displayed as units may or may not be physical units, may be located in one place, or may be distributed on a plurality of network units. Some or all of the units may be selected based on actual requirements to implement the objectives of the solutions of this embodiment.

In addition, functional units in this embodiment of this disclosure may be integrated into one processing unit, each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium (e.g., non-transitory storage medium). Based on such an understanding, the technical solutions of this application essentially, or the part contributing to the related art, or all or a part of the technical solutions may be implemented in a form of a software product. The computer software product is stored in a storage medium, and includes several instructions for instructing a computer device (which may be a terminal, a server, a network device, or the like) to perform all or some of the operations of the methods described in the embodiments of this application. The foregoing storage medium includes any medium that can store a computer program, such as a USB flash drive, a removable hard disk, a read-only memory (ROM), a random access memory (RAM), a magnetic disk, or an optical disc.

In this disclosure, a unit and a module may be hardware such as a combination of electronic circuitries; firmware; or software such as computer instructions. The unit and the module may also be any combination of hardware, firmware, and software. In some implementation, a unit may include at least one module. Each unit or module can be implemented using one or more processors (or processors and memory). Likewise, a processor (or processors and memory) can be used to implement one or more units or modules. Moreover, each unit or module can be part of an overall unit or module that includes the functionalities of the unit or module.

The foregoing descriptions and embodiments are merely intended to describe the technical solutions of this application, rather than limit this application. Although this application is described in detail with reference to foregoing embodiments, a person of ordinary skill in the art should understand that modifications can still be made to the technical solutions described in foregoing embodiments or equivalent replacements can be made to some technical features thereof, without departing from the spirit and the scope of the technical solutions of embodiments of this application.

What is claimed is:

1. A method for data processing, performed by a computer device, the method comprising:
obtaining a control instruction packet transmitted by a server, the control instruction packet comprising a to-be-processed control instruction and a time stamp at which the server transmits the to-be-processed control instruction;
determining whether the to-be-processed control instruction is time sensitive;
in response to the to-be-processed control instruction being a time sensitive control instruction, reading the time stamp from the control instruction packet, and reading the to-be-processed control instruction from the control instruction packet, the time sensitive control instruction being used for cooperatively controlling, with another control instruction, a terminal to complete a common task, and the terminal responds to the time sensitive control instruction and the another control instruction based on a preset sequence when executing the common task;
determining a transmitting order of the to-be-processed control instruction based on the time stamp; and
transmitting the to-be-processed control instruction to the terminal based on the transmitting order, so the terminal being perform an operation corresponding to the to-be-processed control instruction.

2. The method according to claim 1, wherein the control instruction packet further comprises a type identifier, the type identifier indicates whether the to-be-processed control instruction is time sensitive, and wherein determining whether the to-be-processed control instruction is time sensitive comprises:
obtaining the type identifier from the control instruction packet; and
determining, based on the type identifier, whether the to-be-processed control instruction is time sensitive.

3. The method according to claim 2, wherein before obtaining the type identifier from the control instruction packet, the method further comprises:
obtaining a packet length of the control instruction packet; and
obtaining the type identifier from the control instruction packet if it is determined that the packet length is greater than a data length threshold.

4. The method according to claim 2, wherein determining, based on the type identifier, whether the to-be-processed control instruction is time sensitive comprises:
determining that the to-be-processed control instruction is time sensitive if the type identifier is a time sensitive identifier.

5. The method according to claim 2, wherein the control instruction packet further comprises a first checksum, and wherein determining, based on the type identifier, whether the to-be-processed control instruction is time sensitive comprises:
if the type identifier is a time sensitive identifier, obtaining the first checksum from the control instruction packet, and obtaining a plurality of bytes located before the first checksum from the control instruction packet;
performing checksum calculation on the plurality of bytes, to obtain a second checksum;
performing consistency comparison between the first checksum and the second checksum, to obtain a comparison result; and
determining that the to-be-processed control instruction is time sensitive if the comparison result indicates that the first checksum is consistent with the second checksum.

6. The method according to claim 1, wherein: determining the transmitting order of the to-be-processed control instruction based on the time stamp comprises:
determining the transmitting order of the to-be-processed control instruction based on the time stamp comprises:
determining a target position of the to-be-processed control instruction in a message queue based on the time stamp, and buffering the to-be-processed control instruction at the target position, the message queue buffering a plurality of control instructions that are used for controlling the terminal to execute the common task, and the target position indicates a transmitting order of the to-be-processed control instruction in the plurality of control instructions; and
transmitting the to-be-processed control instruction to the terminal based on the transmitting order comprises:
reading the to-be-processed control instruction from the target position in the message queue, and transmitting the to-be-processed control instruction to the terminal.

7. The method according to claim 6, wherein the control instruction packet further comprises an instruction cycle, and wherein determining the target position of the to-be-processed control instruction in the message queue comprises:
obtaining the instruction cycle from the control instruction packet; and
determining the target position of the to-be-processed control instruction in the message queue based on the time stamp and the instruction cycle.

8. The method according to claim 7, wherein:
the method further comprises starting an instruction transmitting timer, wherein a triggering time interval of the instruction transmitting timer being equal to the instruction cycle; and
reading the to-be-processed control instruction from the target position in the message queue, and transmitting the to-be-processed control instruction to the terminal comprises:
when the instruction transmitting timer reaches a transmitting time point based on the triggering time interval, if it is determined that the transmitting time point corresponds to the to-be-processed control instruction, reading the to-be-processed control instruction from the target position in the message queue, and transmitting the to-be-processed control instruction to the terminal.

9. The method according to claim 1, wherein the computer device is a user plane function device in a network, the server transmits the to-be-processed control instruction to the terminal through the network, a respective clock synchronization device is separately deployed on each of the server and the user plane function device, and the respective clock synchronization device is used to control time consistency between the server and the user plane function device.

10. The method according to claim 1, further comprising:
forwarding the to-be-processed control instruction to the terminal if it is determined that the to-be-processed control instruction in the control instruction packet is not the time sensitive control instruction.

11. A device comprising a memory for storing computer instructions and a processor in communication with the memory, wherein, when the processor executes the computer instructions, the processor is configured to cause the device to:
obtain a control instruction packet transmitted by a server, the control instruction packet comprising a to-be-processed control instruction and a time stamp at which the server transmits the to-be-processed control instruction;
determine whether the to-be-processed control instruction is time sensitive;
in response to the to-be-processed control instruction being a time sensitive control instruction, read the time stamp from the control instruction packet, and read the to-be-processed control instruction from the control instruction packet, the time sensitive control instruction being used for cooperatively controlling, with another control instruction, a terminal to complete a common task, and the terminal responds to the time sensitive control instruction and the another control instruction based on a preset sequence when executing the common task;
determine a transmitting order of the to-be-processed control instruction based on the time stamp; and
transmit the to-be-processed control instruction to the terminal based on the transmitting order, so the terminal perform an operation corresponding to the to-be-processed control instruction.

12. The device according to claim 11, wherein the control instruction packet further comprises a type identifier, the type identifier indicates whether the to-be-processed control instruction is time sensitive, and wherein, when the processor is configured to cause the device to determine whether the to-be-processed control instruction is time sensitive, the processor is configured to cause the device to:
obtain the type identifier from the control instruction packet; and
determine, based on the type identifier, whether the to-be-processed control instruction is time sensitive.

13. The device according to claim 12, wherein, before the processor is configured to cause the device to obtain the type identifier from the control instruction packet, the processor is configured to further cause the device to:
obtain a packet length of the control instruction packet; and
obtain the type identifier from the control instruction packet if it is determined that the packet length is greater than a data length threshold.

14. The device according to claim 12, wherein, when the processor is configured to cause the device to determine, based on the type identifier, whether the to-be-processed control instruction is time sensitive, the processor is configured to cause the device to:
determine that the to-be-processed control instruction is time sensitive if the type identifier is a time sensitive identifier.

15. The device according to claim 12, wherein the control instruction packet further comprises a first checksum, and wherein, when the processor is configured to cause the device to determine, based on the type identifier, whether the to-be-processed control instruction is time sensitive, the processor is configured to cause the device to:
if the type identifier is a time sensitive identifier, obtain the first checksum from the control instruction packet, and obtain a plurality of bytes located before the first checksum from the control instruction packet;
perform checksum calculation on the plurality of bytes, to obtain a second checksum;
perform consistency comparison between the first checksum and the second checksum, to obtain a comparison result; and
determine that the to-be-processed control instruction is time sensitive if the comparison result indicates that the first checksum is consistent with the second checksum.

16. A non-transitory storage medium for storing computer readable instructions, the computer readable instructions, when executed by a processor, causing the processor to:
obtain a control instruction packet transmitted by a server, the control instruction packet comprising a to-be-processed control instruction and a time stamp at which the server transmits the to-be-processed control instruction;
determine whether the to-be-processed control instruction is time sensitive;
in response to the to-be-processed control instruction being a time sensitive control instruction, read the time stamp from the control instruction packet, and read the to-be-processed control instruction from the control instruction packet, the time sensitive control instruction being used for cooperatively controlling, with another control instruction, a terminal to complete a common task, and the terminal responds to the time sensitive control instruction and the another control instruction based on a preset sequence when executing the common task;
determine a transmitting order of the to-be-processed control instruction based on the time stamp; and
transmit the to-be-processed control instruction to the terminal based on the transmitting order, so the terminal perform an operation corresponding to the to-be-processed control instruction.

17. The non-transitory storage medium according to claim 16, wherein the control instruction packet further comprises a type identifier, the type identifier indicates whether the to-be-processed control instruction is time sensitive, and wherein, when the computer readable instructions cause the processor to determine whether the to-be-processed control instruction is time sensitive, the computer readable instructions cause the processor to:
obtain the type identifier from the control instruction packet; and
determine, based on the type identifier, whether the to-be-processed control instruction is time sensitive.

18. The non-transitory storage medium according to claim 17, wherein, before the computer readable instructions cause the processor to obtain the type identifier from the control instruction packet, the computer readable instructions cause the processor to:
obtain a packet length of the control instruction packet; and
obtain the type identifier from the control instruction packet if it is determined that the packet length is greater than a data length threshold.

19. The non-transitory storage medium according to claim 17, wherein, when the computer readable instructions cause the processor to determine, based on the type identifier, whether the to-be-processed control instruction is time sensitive, the computer readable instructions cause the processor to:
determine that the to-be-processed control instruction is time sensitive if the type identifier is a time sensitive identifier.

20. The non-transitory storage medium according to claim 17, wherein the control instruction packet further comprises a first checksum, and wherein, when the computer readable instructions cause the processor to determine, based on the type identifier, whether the to-be-processed control instruction is time sensitive, the computer readable instructions cause the processor to:
if the type identifier is a time sensitive identifier, obtain the first checksum from the control instruction packet, and obtain a plurality of bytes located before the first checksum from the control instruction packet;
perform checksum calculation on the plurality of bytes, to obtain a second checksum;
perform consistency comparison between the first checksum and the second checksum, to obtain a comparison result; and
determine that the to-be-processed control instruction is time sensitive if the comparison result indicates that the first checksum is consistent with the second checksum.
